(19) United States
(12) Patent Application Publication
(10) Pub. No.: US 2006/0236671 A1
(43) Pub. Date: Oct. 26, 2006

(54) Power rake

(76) Inventors: Andrew Goodwin Summerville, Goshen, CT (US); Ian Michael Summerville, Goshen, CT (US)

Correspondence Address: Andrew G. Summerville Jr., 120 Pie Hill Rd., Goshen, CT, 06756, US

(21) Appl. No.: 11/111,549

(22) Filed: Apr. 22, 2005

(51) Int. Cl. A01D 84/00

(52) U.S. Cl. 56/378

(57) ABSTRACT

A high performance powered raking device comprising a rotatable mounting element with major axis of rotation horizontally disposed and one or more rake-heads pivotally attached thereto in class-1 or class-3 lever configuration with pivotal axes of said levers parallel to and radially disposed from said major axis of rotation on uniform circumferential centers is described. A provision for integrating a selectable directional blower is included.

### REFERENCES CITED

U.S. Patent Documents

| | | | |
|---|---|---|---|
| 879,759 | February 1908 | French | non classified |
| 3,308,612 | March 1967 | Oblinger | 56/27 |
| 3,564,823 | February 1971 | Rhodes | 56/27 |
| 4,299,079 | November 1981 | Lambert | 56/16.7 |
| 4,516,393 | May 1985 | Lambert | 56/400.2 |

### FEDERALLY SPONSORED RESEARCH AND DEVELOPMENT

Not Applicable

### SEQUENCE LISTING, TABLES, COMPUTER PROGRAM LISTINGS

Not Applicable

### BACKGROUND OF THE INVENTION

(1) Field of the invention

The subject invention pertains to U.S. Patent Classification 56 “Harvesters

(2) Description of the Prior Art

Prior to the present invention, countless efforts have been made to simplify the laborious task of raking lawns and/or grassy areas with only limited success. A thorough search of the prior art has revealed many creative efforts, yet beyond the simple broom rake, the only solution that has enjoyed any significant level of commercialization is the blower. Blowers are being used in increasing numbers; they are lightweight, reliable, and easy to use. Unfortunately, they don't perform very well, lacking penetration capability they're only capable of moving light surface matter.

Recently, a family of leaf-vacuums started to appear in the marketplace. These are arguably an improvement over the blower solution, in that leaves and clippings are more controlled. The problem, as in the case of the blower, is that the device is only capable of removing light surface matter. Beyond that, the vacuum family of solutions accumulate the leaves and clippings, and therefore the gathering process has to stop periodically while the containment device is driven to a disposal area, opened, emptied, re-closed, and then driven back to resume gathering. Mulchers have been adapted to these devices to improve volumetric efficiency hence lessening the frequency of stoppages, but they are still generally ineffective.

Lawn sweepers represent another family of efforts to resolve the problem of yard clearing. These walk-behind devices typically comprise a set of rotary brooms that are either power driven, or mechanically driven by one of the supporting wheels. The debris is swept into a large accumulator that is typically positioned between the rotary broom and the operator. Penetration is improved over the blower and/or vacuum solutions but still not good. Unfortunately for the operator, as the accumulator becomes filled, the weight of the collection bin can become excessive and unmanageable, especially in cases where leaves or grass clippings are wet or have high water content. While sweepers do provide an improved level of effectiveness, they are cumbersome and require periodic trips to a disposal area to empty the accumulator.

Another family of leaf gathering devices comprises a rotating drum with circumferentially disposed prongs that spear the leaves and then transfer them to a position where they can be stripped from the prong and gathered into an accumulator. These devices have not enjoyed any significant level of commercialization, and are thought to be generally ineffective.

Still another family of efforts is found in a genre entitled “dethatchers”, finally we move into a family of powered devices that is capable of penetrating below the surface of the lawn, and indeed able to retrieve old clippings and other matter that lay below the lawn's surface. These devices typically comprise a series of spring-wire tines that effectively reach down below the surface and retrieve dead clippings. The thatch is then either captured into an accumulator device, or left on the lawn's surface to be raked up later. Dethatchers attack the penetration issue with a good level of effectiveness, but are not so effective in their handling of leaves, either poking through or cutting the leaves with their sharp tines. Further, they are aggressive to the point that the “tear” at the surface as opposed to “raking” the surface.

The device that has enjoyed by far the greatest level of commercialization is the manual broom type leaf rake, or lawn rake. Marketing drivers are clearly economy, availability and quality of performance. While it requires the greatest amount of manual labor to accomplish its task, it performs it better than any of the above referenced solutions. Countless attempts have been made to improve even this simple device, but at the time of this writing, a simple and clean manual leaf rake, fabricated with bamboo, spring-steel, or plastic tines, provides the highest quality of commercialized solutions, and overwhelmingly dominates the market.

### BRIEF SUMMARY OF THE INVENTION

The subject invention is a uniquely configured automated rake, a device that mimics the motions and forces that are typically applied during a manual raking effort, but automated to the point of providing very real benefits to the user such as precision and speed. This invention has been successfully demonstrated to provide many times the productivity of a human powered leaf rake with improved precision, in a balanced and agile design.

Its inventors feel that rather than compromising the primary purpose of the device which is “raking” with debris accumulators and/or self propulsion devices, the invention will focus on performing the task of raking, and performing the task better than any of the aforementioned methods, be they powered or manual. The device of the subject invention keeps the tines in contact with the ground for an extended period due to its unique configuration, and will provide on the order of 300 to 500 strokes per minute as the operator walks casually behind the device which boasts large easy rolling wheels and counterweights for a mass-balanced design.

The device of the subject invention provides a lightweight and agile solution that is simple, robust, and easy to use, while offering quantum gains in productivity over other methods. Further, the subject device mimics manual raking motions in a most effective manner. It doesn't accumulate clippings or leaves, but rather throws the matter forward, using a blower as an assist to provide a most effective means of raking and gathering leaves and debris. It should be noted that most powered devices prior to the subject invention pull the debris toward the operator and into a collection device, the subject invention throws the debris forward and away from the operator, with a directional blower means provided to move the debris to the right or to the left of the forward path of the device at the will of the operator. Since leaves and clippings aren't contained, the user isn't encumbered in dealing with the associated weight, nor is he/she bothered with the interruptions of emptying out the accumulator. Instead, the device is used to rake the debris into piles for manual removal at a chosen time.

It is an object of the invention to obtain performance quality levels heretofore only obtainable through use of a manual broom rake.

Another object of the invention is to mimic the motions and applied forces of a manual broom rake to achieve superior quality performance.

Another object of the invention is to provide a device that will self-adjust to an imperfect and variable lawn surface.

Another object of the invention is to provide the precision and speed of a powered device thereby offering high levels of productivity.

Another object of the invention is to provide the above objectives in a light, maneuverable and agile format.

Still another object of the invention is to provide robustness that will endure many seasons of use.

A further object of the invention is to provide simplicity to a point that an individual of average mechanical capability can understand the design intent, and can properly maintain the device with simple tools.

Still another object of the invention is to provide rake-heads that can be removed and replaced easily by an individual of average mechanical capability.

Yet another object of the invention is to provide the above objects in a manufacturable and cost-effective format.

A final object of the subject invention is to encompass user safety among its design considerations.

While not intended to describe the full scope of the subject invention, in brief and in general, the stated objects of the invention are accomplished in a configuration that provides a rotatable mounting means in the form of an elongated cylinder with major axis essentially horizontally disposed, capped at each end to provide a surface for bearings to be mounted with rotatable axes concentric to said major axis, in-turn supported on a common shaft through said bearings; thus providing a rotatable mounting means positioned on an essentially horizontal shaft. While the rotational mounting means does not have to be in the configuration of an elongated cylinder, this form is preferred since it is geometrically clean, esthetically pleasing, and provides sufficient mass inertia to dampen vibrations incurred during use. One or more pivotally mounted rake-heads applied in class-1 lever configuration are attached to said rotatable mounting element with pivotal axes oriented essentially parallel to and radially disposed from said major axis of rotation, and on uniform circumferential centers. With the tips of the rake tines directed outward and away from said elongated cylinder's major axis of rotation, a spring force is applied to the opposite end of the class-1 lever rake-head (opposite the tines) acting in the general direction of said major axis of rotation. A fixed energy absorbing stop serves to limit the pivotal displacement of the rake-head as imposed by the spring at an angle that properly positions the tines for contact with the ground. With said rotatable mounting element and attached rake-heads so disposed, two large wheels are mounted beyond the distal ends of said cylinder and onto said shaft, with said wheels properly sized to allow sufficient interference of the tines with the grounds surface. An alternate design uses a class-3 lever configuration in lieu of the class-1 lever configuration(s) referenced above; this alternate design is further explained in the detailed description that follows and in the attached drawings.

Said elongated cylinder may then be powered into rotation such that said rake-heads in said class-1 or class-3 lever configurations contact the grounds surface under spring load, with said lever configurations compensating for the disturbed orbital path of the tines as dictated by the earth's surface, allowing the rake-heads to follow the ground's surface, displacing inward as required as constrained by said pivotal axis.

The above described subassembly including the horizontally disposed rotatable mounting element in the form of an elongated cylinder, the end-caps, bearings, and shaft onto which it is mounted, and the rake-heads pivotally mounted in class-1 or class-3 lever configuration as described, with fixed energy absorbing stops, shall be referred to as the “functional turret” or “turret” going forward, in order to simplify the text used in further descriptions.

At each of the distal ends of the functional turret, onto the shaft between the capped elongated cylinder and each of the supporting wheels; couplings are positioned that link the turret as described, to a simple yoke frame. Said frame provides two initial structural members extending from said couplings toward the operator affixed to the distal ends of a cross-member mounting plate to which a lightweight engine and gear-reducer are mounted. Extending further toward the operator from said plate, a second extension of said frame provides handles for the operator and mounting surfaces for control mechanisms. Forward of said wheels, said initial frame members extend away from the operator, supporting twin counterweights, one on each extended initial frame member, that serve to stabilize the impulse raking forces and to offset the load of the frame and lightweight power transmission so that the operator encounters a balanced and neutral feel of the handle extension, even though the device is only supported by two wheels.

A small lightweight engine is affixed to said mounting plate in such a manner that its output shaft is positioned for coupling through a pulley arrangement or other acceptable power-transmission means to a lightweight gear-reducer. In this way, a rotational speed reduction may be effected between the driver and driven pulleys, thereby limiting the reducer input RPM to acceptable rotational speeds. If for example the desired gearbox input RPM is only ½ of the maximum loaded engine RPM a 1:2 ratio pulley arrangement may be easily provided.

Said lightweight gear-reducer then provides a high-ratio reduction with its output shaft offering ample torque at an appropriate speed to drive the functional turret. A second pulley arrangement makes the final connection between the gearbox output-shaft and said functional turret to which a drive pulley is concentrically affixed to one of the said end-caps. Again an opportunity is created to tweak the relative rotational speed between the two elements (gearbox output to functional turret) through the targeted selection of pitch diameter ratios, offering still higher applied torque at the turret. Note that while other power transmission means may be applied, the pulley arrangement offers simplicity, efficiency, and economy.

Providing a centrifugal clutch at the engines output pulley/shaft adds a high level of safety and controllability, wherein a twist-grip throttle provides immediate feedback to the drive.

The proper selection of the engine should provide a power band that best suits the needs of the application. Said twist-grip throttle will provide seamless variable-speed capability that will make best use of an engine with a generally flat RPM to torque profile, thus offering the device ample torque over a broad range of operating speeds.

Functionality of the powered raking device is further improved through the integration of a blower unit whose air-stream may be directed into either of two discharge tubes, to the left side or to the right side of the machine by a remotely operated diverter plate mounted within a ‘Y’ tube coupling. The preferred drive arrangement of the subject invention has both blower and the functional turret being powered from a single engine for the sake of lightweight and simplicity. It should be noted however that blower can also be provided with its own discrete drive engine.

The operator then has the ability and control provided to blow the leaves or debris forward and to the left, or forward and to the right of the path of the powered raking device. The selectable air-stream blower used in combination with the functional turret mounted and driven as described above, provides a highly productive and controllable machine.

With safety being a key object of this invention, a significant level of control is offered by the centrifugal clutch/twist-grip throttle combination. With this arrangement, turret speed can be instantly adjusted and sustained, or stopped. As a secondary safety measure, a stone shield is affixed to the aforementioned mounting plate, precluding the possibility of any stray matter from striking the operator. A ternary safety measure in the form of local guarding is applied around pulleys and belts to guard the operator from pinch hazards. In the interest of ergonomics, counterweights are mounted onto the forward frame to offset the load of the lightweight power transmission and the upper frame in such a manner that the operator interface is balanced and maneuverability is established.

### GENERAL DESCRIPTION OF THE DRAWINGS

FIG. 1 is a left elevation view of the subject invention with belt guards removed to best illustrate the mechanical drive configuration between the gear-reducer and the functional turret.

FIG. 2 is a plan view of the subject invention illustrating the general layout of the yoke-frame and the power transmission, depicting also the relative location of two companion rake-heads mounted in an equally circumferentially disposed manner upon a horizontally disposed rotary cylinder. Two supporting wheels are shown mounted on a common shaft defining the major axis of rotation of the turret.

FIG. 3 is a left elevation similar to that of FIG. 1, but with the nearside wheel removed to clearly depict the simplicity of the drive and the unique class-1 lever arrangement of the rake-heads as mounted on a horizontally disposed mounting element in the form of an elongated cylinder.

FIG. 4 is a cross-sectional view of the turret taken along line A-A of FIG. 2 as viewed along the major axis of rotation depicting a class-1 lever arrangement with lower rake shown displaced from home position as if under contact with ground.

FIG. 5 is a cross-sectional view of the turret similar to FIG. 4 but depicting a class-3 lever configuration as opposed to the class-1 lever configuration of FIG. 4.

FIG. 6 is a sequential view illustrating the class-1 lever action of one of the companion rake-heads in ground contact as the turret drives through 100 degrees of active rotation. Note that the wheel is not in rotation in this sequence, only the functional turret.

FIG. 7 is an illustrative view depicting the active motion of a manual broom rake as compared to the respective motions of the subject invention.

FIG. 8 is a left elevation of the present invention with a blower unit integrated to assist in gathering large piles of leaves, clippings, or debris.

FIG. 9 is a plan view of the present invention with blower unit attached. Note that the blower unit and the functional turret are driven from a common lightweight engine.

FIG. 10 is a plan view of the blower tubes and manifold configuration depicting the air-flow diverter that directs air to the left or the right tubes.

FIG. 11 is a close-up sectional view of the class-1 lever attachment configuration taken along line A-A of FIG. 2.

FIG. 12 is a close-up sectional view similar to FIG. 11 but illustrating a class-3 lever configuration.

### DESCRIPTION OF THE PREFERRED EMBODIMENT

To convey a clear understanding of the principles of the subject invention, references will now be made to the drawings and specific language will be used. The use of said drawings and specific language is not intended in any way to limit the scope of the invention.

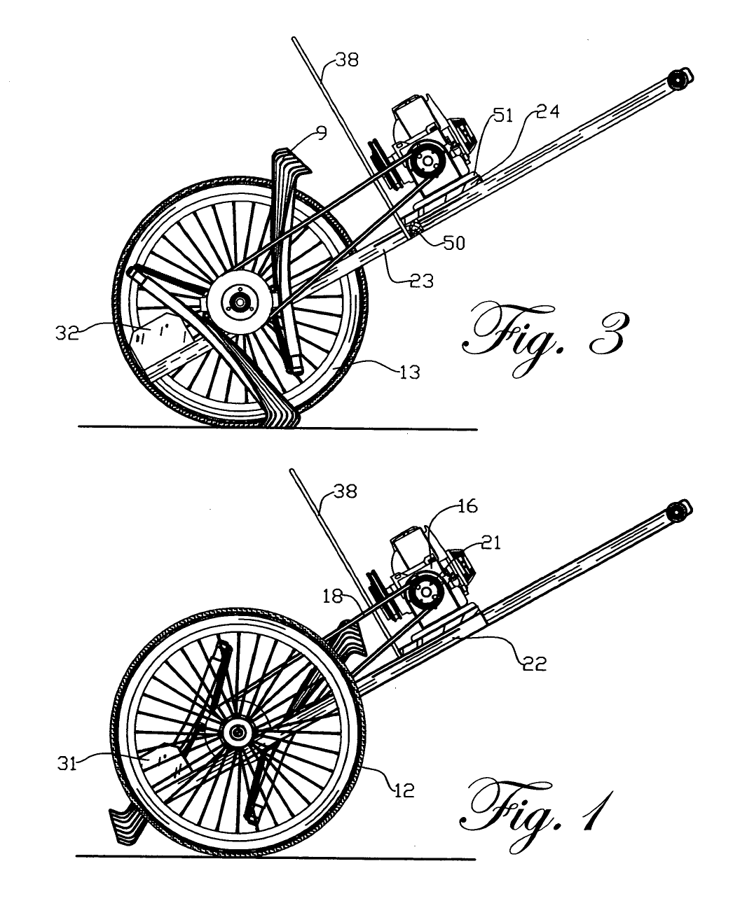

Now referring to the drawings; FIG. 1 illustrates the power-motivated rake of the subject invention with its simple form supported by two wheels mounted coaxially with the rotary turret, and nearside wheel 12 in clear view. The frame is seen extending upward toward the operator position, and gear-box 16 is seen affixed to said frame with gearbox output pulley 21 driving the functional rotary turret's elongated cylinder through turret drive belt 18. Stone guard 38 is shown affixed to the frame, positioned between the turret and the operator to preclude the possibility of stones or debris striking the operator. All frame members are preferably constructed of wood or structural forms of lightweight metals to provide low mass and agility for ease of handling. Commercially available turret gear-box 16 is fabricated of aluminum or other lightweight metal to further minimize weight and improve agility. Note that counterweight 31 mounted on extended frame member 22 acts to offset the weight of the upper frame and the power train, and offers sufficient mass to dampen vibration and to keep the power-rake's functional turret planted firmly on the ground.

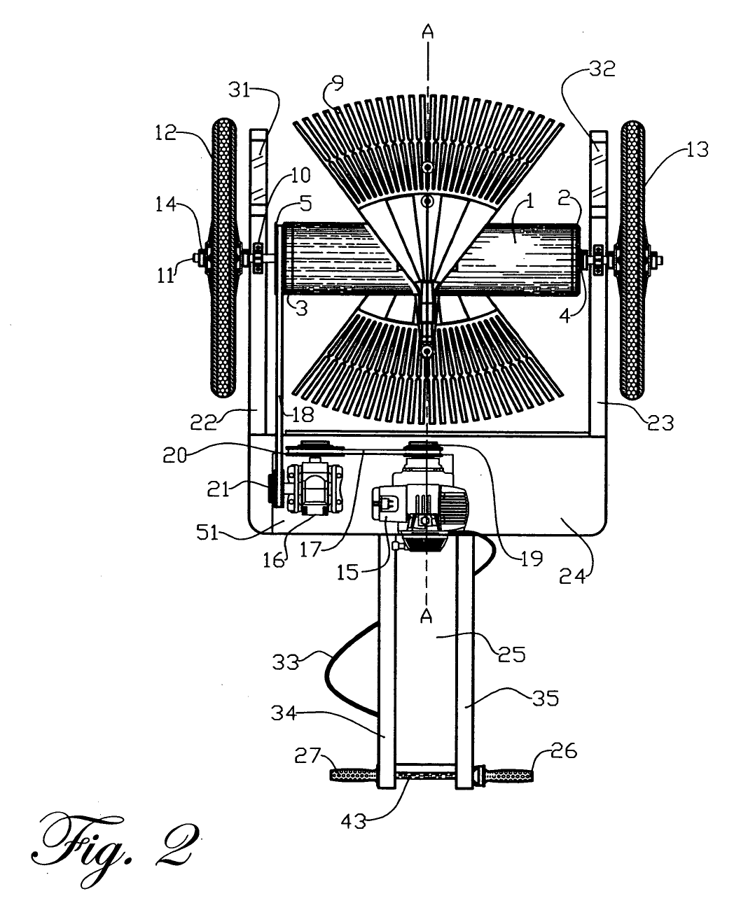

In FIG. 2, the simple yoke frame is shown supporting the power transmission and coupling a horizontally disposed elongated cylinder 1 with companion rakes 9 pivotally attached in class-1 lever configuration with pivotal axes parallel to and radially disposed from the major axis of said horizontally disposed elongated cylinder 1 on uniform circumferential centers. Supporting wheels 12 and 13 are shown mounted on shaft 11, in-turn supporting elongated cylinder 1 through turret bearings 4 centrally affixed to turret end caps 2 and 3 which are aligned and rigidly affixed to elongated cylinder 1 as depicted. Frame members 22 and 23 are also coupled to shaft 11 through shaft supports 10. Wheels 12 and 13 rotate freely upon integral bearings (not illustrated) and are captured axially by clamping collars 14. The simple frame also includes cross-frame mounting plate 24 and control extension member 25 to which handle 27 and twist grip throttle 26 are coupled through dowel 43. Frame members 34 and 35 affixed to extension member 25 add rigidity to the upper frame. Transmission mounting plate 51 supports lightweight engine 15 and lightweight gearbox 16 and provides adjustable center capability for belt tensioning of pulley belts 17 & 18. Twist-grip throttle 26 coupled through control cable 33 dictates rotational speed of engine 15, and hence controls the speed based engagement of centrifugal clutch-pulley 19. Upon engagement of clutch-pulley 19, input shaft of gearbox 16 is driven by belt 17 through pulley 20. Note that gearbox 16 input RPM may be adjusted with respect to engine 15 output RPM through the pitch diameter ratio of pulleys 19 and 20. In-turn, gearbox 16 output-shaft drives pulley 21 and subsequently turret drive pulley 5 through belt 18, wherein drive pulley 5 is concentrically aligned with shaft 11 and affixed to end-cap 3. It should be clear that although major axis of elongated cylinder 1 and wheels 12 and 13 are mounted concentric to and onto major common shaft 11, they are completely independent, with elongated cylinder 1 being driven by engine 15 through gearbox 16, and wheels 12 and 13 passive, only responding to motion imparted by the operators applied forces, or as the case may be, by another motivating force such as a tractor if appropriately coupled. Counterweights 31 and 32 are clearly depicted applying balancing loads to the yoke-frame, making load forces at twist-grip throttle 26 and handle 27 essentially weight neutral.

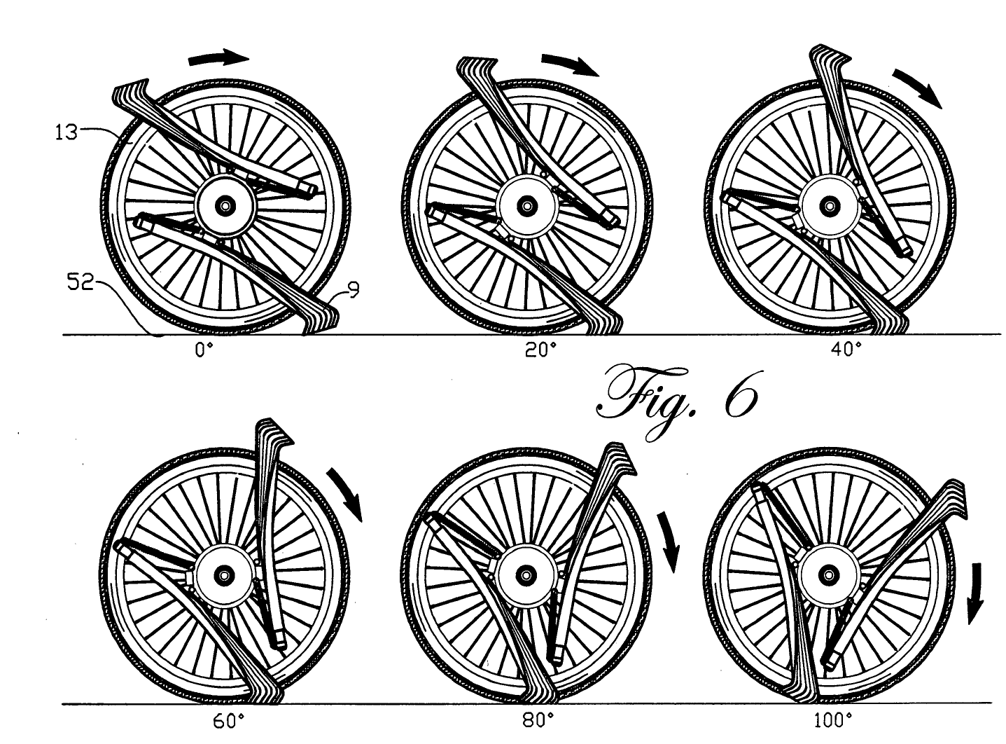

FIG. 3 with nearside wheel 12 and nearside support member 22 removed, illustrates the extreme simplicity of the device. Farside wheel 13 is shown in the background. In this view, companion rake elements 9 are shown mounted in a class-1 lever arrangement. Rake heads 9 can also be mounted in a class 3 lever arrangement if so desired, see FIG. 5. FIG. 3 clearly depicts counterweight 32 mounted on the distal end of far-side frame extension 23, thereby offsetting the weight of the power train. Crossframe support member 50 offers structural support to crossframe mounting plate 24 shown with power transmission mounting plate 51 attached thereto. Note that crossframe support member 50 also provides a mounting means for stone shield 38.

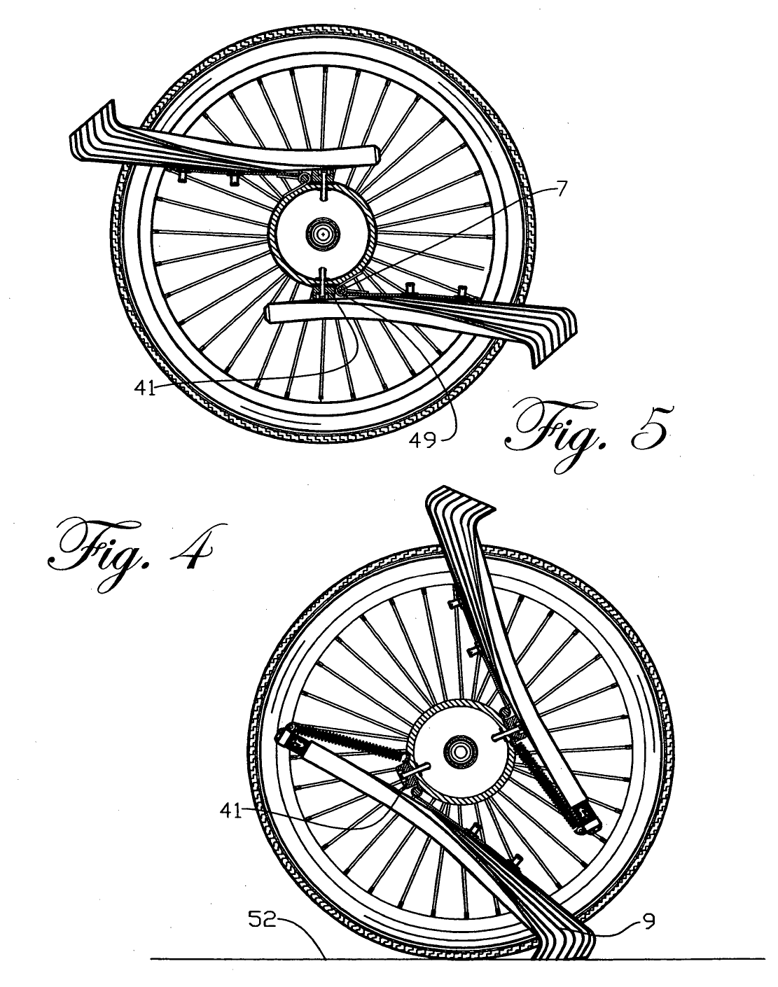

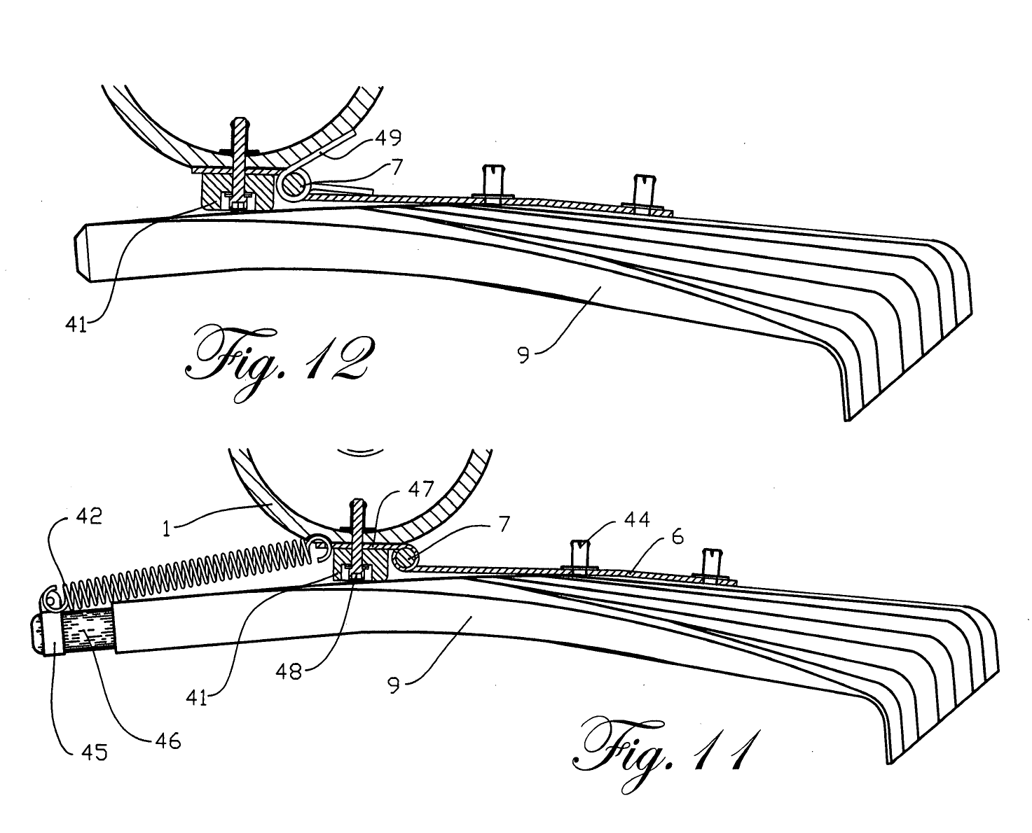

The unique arrangement of the class-1 lever configuration rake-head mounts may be seen in FIG. 4 wherein lower companion rake-head 9 is shown in contact with the ground's surface 52, with said surface 52 pivotally displacing rake-head 9 away from its home location against fixed energy absorbing stop 41. Here, the turret has been sectioned along line A-A in FIG. 2 so that the viewer may clearly observe a preferred mounting technique. FIG. 11 shows an enlarged view of the mounting detail of FIG. 4 wherein rake-head 9 is attached to hinge 6 by means of rake attachment fittings 44. With hinge anchor plate 47 firmly affixed to elongated cylinder 1, pivotal motion of rake head 9 acts about hinge pin 7. Angular displacement of rake-head 9 is restricted by fixed energy absorbing stop 41 affixed to spring anchor plate 47 and elongated cylinder 1 through attachment screw 48. Rake head 9 is loaded onto its normal home location against fixed energy absorbing stop 41 by extension spring 42 coupled to rake-head 9 through spring-anchor 45 affixed to stub-handle 46. Note that the opposite end of spring 42 is affixed to spring anchor plate 47. It may be seen that this unique mount allows a load acting against the tines of rake-head 9 to pivotally displace rake-head 9 in a counter-clockwise direction (as viewed) against spring counter-load, with extension spring 42 always attempting to return class-1 lever rake-head 9 to its home position against fixed energy absorbing stop 41.

FIG. 5 displays the companion rakes mounted in a class-3 lever configuration. It may be seen that while the tine end of the lever is similar to that portrayed in the aforementioned class-1 lever arrangement of FIG. 4, the class-3 version pivotally loads the rake-head by means of one or more torsional springs 49 acting on the tine side of the pivotal axis of hinge pin 7 until fixed energy absorbing stop 41 is contacted. The class-3 lever configuration allows a shortened distal end of the rake-head opposite the tine end. This configuration offers advantages in that it provides improved ground clearance over the class-1 configuration. It's worth noting however, that the extended (effort) end of the class-1 arrangement is protected by the displaced tines of the companion rake-head as illustrated in FIG. 4, and further that the distal end of said class-1 lever may be otherwise shortened by modifying the length of spring 42 and the length of stub-handle 46. The mounting details of the class-3 lever configuration may be seen in an enlarged view in FIG. 12 in which torsion spring 49 is shown acting about hinge-pin 7, loading rake-head 9 in its class-3 posture against its home position at fixed energy absorbing stop 41.

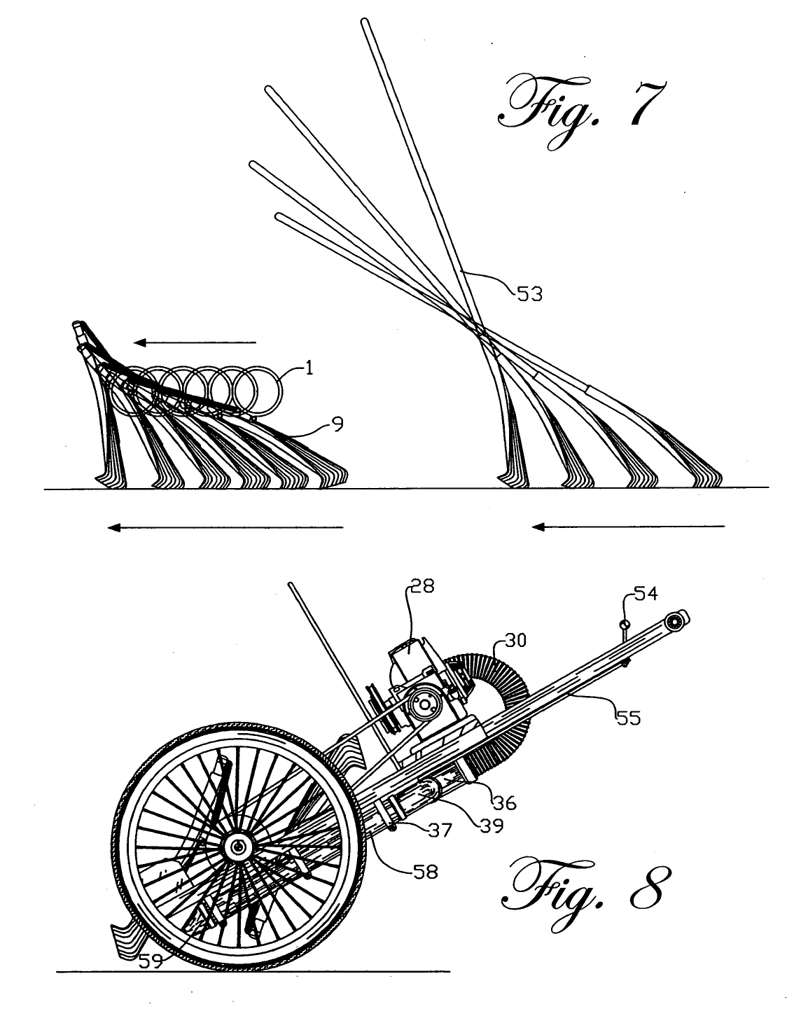

FIG. 6 illustrates the raking motion of one of the companion rake heads as it is driven through one-hundred degrees of rotation in twenty degree increments. Note that only the aforementioned functional turret is in rotation in the sequence and farside wheel 13 is static for purposes of illustration. It may be seen that the lever action of the unique mounting configuration extends the duration of contact of rake-heads 9 with the ground 52 and effectively simulates a manual raking action. Further, the same unique arrangement presents the rake-heads to the earth in much the same attitude as a manual broom rake. When outfitted with two rake heads, for each full rotation of the rotary turret, the companion rake-heads are in contact with the surface of the ground for approximately two-hundred degrees; more than one-half of each rotational cycle. FIG. 7 further depicts the similarity of raking motions by contrasting the motion of a manual broom rake 53 in direct comparison to the raking action of rake-head 9 of the subject invention, as carried in rotation and translation by horizontally disposed mounting element, elongated cylinder 1.

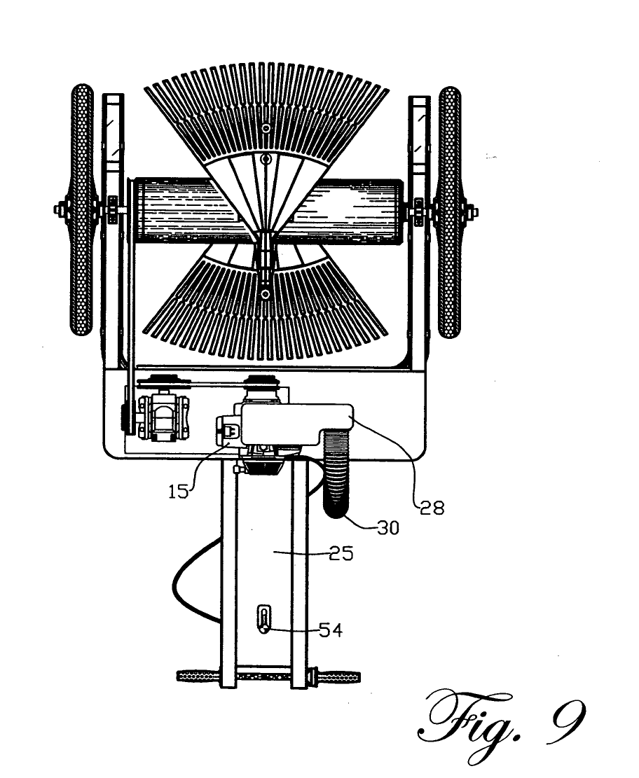

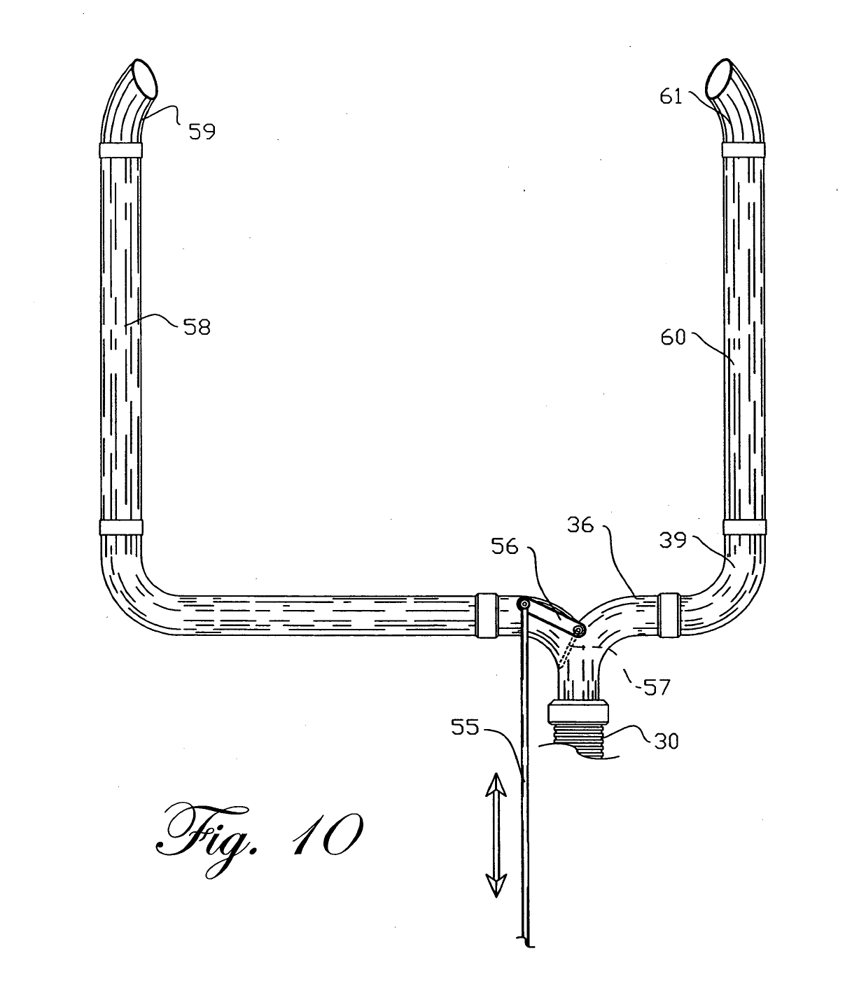

A directional air-stream when used in conjunction with the powered functional turret as described above offers quality of performance heretofore achievable only by using a manual broom rake, plus the ability to throw the leaves or debris to either side of the forward path of the machine. FIG. 8 illustrates an elevation view of the preferred embodiment with a directional blower system integrated. It may be seen that the blower tube 58 is suspended from the yoke frame by hangers 37. Flexible blower tube 30 delivers air from blower unit 28 to ‘Y’ connector 36. Directional air-flow control lever 54 is coupled to throw-rod 55 located beneath the upper frame. Right angle tube fitting 39 directs the airflow down the nearside air-tube 58 to nearside discharge nozzle 59. FIG. 9 adds further clarity showing directional air-flow control lever 54 mounted to frame member 25. In this view, engine 15 is driving both the functional turret and blower 28 to which flexible header tube 30 is attached, directing the air-stream to the tubes mounted below the frame. FIG. 10 shows the preferred air tube configuration wherein flexible header tube 30 can be seen leading into directional ‘Y’ tube 36. Here, throw-rod 55 may be seen coupled to link 56, setting the location of air-flow diverter gate 57 within ‘Y’ tube 36 and subsequently directing the air-stream through right angle tube 39 and right-side air-tube 60 to right-side discharge nozzle 61. By shifting throw-rod 55, link 56 shifts air-flow diverter gate 57 such that the air-stream is diverted through the right angle tube and left air-tube 58 to left discharge nozzle 59. It may be seen that by directing the flow of air through left or right discharge tubes, leaves and debris may be directed to the left or right sides of the forward path of the subject raking device to improve gathering efficiency.

We claim:

1. A powered raking device comprising:
a rotatable mounting element driven to rotate about a horizontally disposed major axis;
said mounting element supporting one or more detachable rake-heads with ground engaging tines, said rake-heads pivotally attached to said mounting element in the configuration of class-1 levers;
with the pivotal axis of each said class-1 lever essentially parallel to and radially disposed from said major axis of rotation on uniform circumferential centers;
each said class-1 lever independently operative with tine-end following said pivotal axis at a greater disposed radius when in orbital rotation about said major axis; and
with applied force acting on each said class-1 lever by centripetal force acting on the tine-end, and/or a spring element loading its respective effort-end essentially toward said orbital center as constrained by its respective pivotal axis;
causing the respective tine end to displace outward, essentially away from said orbital center as constrained by its respective pivotal axis;
until a fixed energy absorbing stop is contacted by each said rake-head, thereby limiting the maximum radial pivotally displaced position of said tines with respect to said major axis of rotation, or otherwise displaced through direct contact with the ground's surface.

2. A powered raking device comprising:
a rotatable mounting element driven to rotate about a horizontally disposed major axis;
said mounting element supporting one or more detachable rake-heads with ground-engaging tines, said rake-heads pivotally attached to said mounting elements in the configuration of class-3 levers;
with the pivotal axis of each said class-3 lever essentially parallel to and radially disposed from said major axis of rotation on uniform circumferential centers;
each said class-3 lever independently operational with tine-end following said pivotal axis at a greater disposed radius when in orbital rotation about said major axis; and
applied force acting on each said class-3 lever by centripetal force acting on the tine-end, and/or a spring element loading the effort zone of the class-3 lever, thereby loading the tine end directly or indirectly away from said orbital center as constrained by its respective pivotal axis;
until a fixed energy absorbing stop is contacted by each said rake-head, thereby limiting the maximum radial pivotally displaced position of said tines with respect to said major axis of rotation, or otherwise displaced through direct contact with the ground's surface.

3. The powered raking device of claims 1 or 2 wherein said rotatable mounting element is an elongated cylinder with said major axis of rotation one with and concentric to the major axis of said cylinder;
said cylinder being capped at each distal end to provide mounting surfaces for bearings concentrically aligned with said major axis of rotation affixed thereto;
rotatably supported upon an elongated shaft through said bearings, thereby allowing powered rotation of said elongated cylinder about said elongated shaft;
with distal ends of said elongated shaft extending beyond the respective ends of said elongated cylinder.

4. The powered raking device of claim 3 coaxially mounted between two supporting wheels on said elongated shaft, with said wheels properly sized to facilitate extended ground engagement of said tines during powered rotation about said elongated shaft, within the pivotal limits of said rake-heads.

5. The powered raking device of claim 4 set within a yoke framework with 1^{st} and 2^{nd} yoke extensions affixed to said shaft between each said supporting wheel and said elongated cylinder;
providing clear passage of rotatably driven pivotal rake-heads;
with at least one cross-member rigidly joining said 1^{st} and 2^{nd} yoke extensions and with a third extension provided there from, for operator interface.

6. The powered raking device of claim 5 with power supplied by an internal combustion engine coupled to a gear-reducer by means of belt and pulleys or other suitable power transmission means, mounted to said cross-member, with output shaft of said gear reducer driving said rotatable mounting element in rotation by means of belt and pulleys or other suitable power transmission means.

7. The powered raking device of claim 6 counterweighted forward of said supporting wheels onto the distal ends of said 1^{st} and 2^{nd} yoke frame extensions, to offset the load of the power transmission and the upper frame, resulting in a light weight or weight neutral operator interface.

8. The powered raking device of claim 6 with a blower unit affixed thereto in combination with a selectable diverter, with remote manual actuation means provided through a lever arrangement or by cable means, to direct air-flow to a left blower tube or a right blower tube mounted to said yoke frame, with directional nozzles placed at the distal ends of said left and right blower tubes, forward of said elongated shaft, and adjacent to said wheels, so positioned to blow leaves and debris to the left or right of the forward path of the subject powered raking device.

9. The powered raking device of claim 6 with a blower unit affixed thereto in combination with a lever or cable actuated means to direct one or more air-stream nozzles to essentially a left or right direction, so positioned to blow leaves and debris to the left or right of the forward path of the subject raking device.

10. The powered raking device of claim 8 with said rotatable mounting element and said blower being powered from a common engine.

11. The powered raking device of claim 9 with said rotatable mounting element and said blower being powered from a common engine.

12. The powered raking device of claim 3 in which said detachable rake heads are discrete units of a simple and inexpensive type such as the poly, bamboo or spring-steel variety typically found on a standard broom rake.

13. The raking device of claim 3 powered and motivated by a primary device such as a tractor.

14. The powered raking device of claim 3 mounted between two supporting wheels on a parallel or non-parallel axis.

15. The powered raking device of claim 6 with a twist-grip throttle provided at the operator interface and with a centripetal clutch operably mounted onto said engines output shaft.

16. The powered raking device of claim 6 with a transparent stone shield mounted onto the cross-member of said yoke-frame.

17. The powered raking device of claim 6 with local guarding placed around driving and driven pulleys and associated connecting belts, or other suitable power transmission means.

18. The powered raking device of claim 6 with one or more pivotally mounted auxiliary wheels attached to support any unbalanced loading of the frame such that the operator interface is weight neutral to the operator.

19. The powered raking device of claim 6 with power from said engine applied to said wheel or wheels so as to motivate the device under the control of the operator.

20. The powered raking device of claim 6 with an accumulator means affixed to said yoke frame, positioned between the rake-heads and the operator, with rake-heads oriented and elongated cylinder driven to rake leaves and debris into said accumulator means, with said accumulator means detachable for purposes of emptying.
